(19) United States
(12) Patent Application Publication
(10) Pub. No.: US 2018/0121063 A1
(43) Pub. Date: May 3, 2018

(54) TECHNIQUES FOR DISPLAYING LAYOUTS AND TRANSITIONAL LAYOUTS OF SETS OF CONTENT ITEMS IN RESPONSE TO USER TOUCH INPUTS

(71) Applicant: Google Inc., Mountain View, CA (US)

(72) Inventors: David Lieb, San Francisco, CA (US); Bernardo Núñez Rojas, San Francisco, CA (US); Eric Charles Henry, San Francisco, CA (US); Ian Mark Jonathan Wilkinson, Santa Clara, CA (US); Juan Carlos Miguel Anorga, San Francisco, CA (US)

(73) Assignee: Google Inc., Mountain View, CA (US)

(21) Appl. No.: 15/561,271

(22) PCT Filed: Mar. 22, 2016
(86) PCT No.: PCT/US2016/023512

§ 371 Date: Sep. 25, 2017

Related U.S. Application Data
(60) Provisional application No. 62/139,233, filed on Mar. 27, 2015.

(51) Int. Cl. G06F 3/0484; G06F 3/0488

(52) U.S. Cl. CPC G06F 3/04845; G06F 3/04883; G06F 3/04842; G06F 2203/04806; G06F 2203/04808; G06F 3/04847

(57) ABSTRACT

A computer-implemented technique can include displaying, at a touch display of a computing system having one or more processors, a first layout of a set of content items. The technique can include receiving, at the touch display, a first touch input from a user, the first touch input comprising two spot inputs. The technique can include receiving, at the touch display, a second touch input comprising a slide input from one of the spot inputs in a direction towards or away from the other spot input, the slide input having a length. The technique can include displaying, at the touch display, one or more transitional layouts of the set of content items based on the direction and length of the slide input. The technique can also include when the user breaks contact with the touch display, displaying, at the touch display, a second layout of the set of content items.

### CROSS-REFERENCE TO RELATED APPLICATIONS

This application claims the benefit of priority to U.S. Provisional Application No. 62/139,233, filed on Mar. 27, 2015. The entire disclosure of the above application is incorporated herein by reference.

### FIELD

The present disclosure relates to display techniques for sets of content items at touch computing systems and, more particularly, to techniques for displaying layouts and transitional layouts of sets of content items in response to user touch inputs.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Computing devices can store a large collection of content items (e.g., content items), which can make it difficult for a user to browse through the collection of content items. For example, the user may identify a particular content item in the collection of content items and may desire to view other content items related to the particular content item. Conventional techniques include dividing the collection of content items into groups, from which the user may then select a group and view its corresponding content items. Switching between these groups, however, can be disjointed. For example, the user may select one of the groups, and then may have to select to return back to a previous group and select a different group. Additionally, relevance or context between the content items can be lost during the switching.

### SUMMARY

A computer-implemented technique is presented. The technique can include displaying, at a touch display of a computing system having one or more processors, a first layout of a set of content items. The technique can further include receiving, at the touch display, a first touch input from a user, the first touch input comprising two spot inputs. The technique additionally can include receiving, at the touch display, a second touch input comprising a slide input from one of the spot inputs in a direction towards or away from the other spot input, the slide input having a length. The technique can also include displaying, at the touch display, one or more transitional layouts of the set of content items based on the direction and length of the slide input. Further, the technique can include when the user breaks contact with the touch display, displaying, at the touch display, a second layout of the set of content items.

A computing system is also presented. The computing system can include a touch display configured to: receive a first touch input from a user, the first touch input comprising two spot inputs, and receive a second touch input comprising a slide input from one of the spot inputs in a direction towards or away from the other spot input, the slide input having a length. The computing system can also include one or more processors configured to control the touch display to: display a first layout of a set of content items, display one or more transitional layouts of the set of content items based on the direction and length of the slide input, and display a second layout of the set of content items when the user breaks contact with the touch display.

In one implementation, the content items are images. In some aspects, the one or more transitional layouts are generated and displayed in real-time with receipt of the second touch input. In some aspects, the first touch input includes three, four or five spot inputs.

In one implementation, at least one of the one or more transitional layouts includes at least one content item of the set of content items being only partially displayed at an outer edge of the touch display. In some cases, the second layout can be different than the first layout.

In some aspects, displaying the one or more transitional layouts includes at least one of: (i) adjusting a size of at least one content item of the set of content items, (ii) adjusting an arrangement of at least one content item of the set of content items, (iii) displaying a subset of the set of content items, and (iv) displaying at least one additional content item in addition to the set of content items. Further, in some implementations adjusting the size of at least one content item of the set of content items can include maintaining margins between each content item.

The touch display can include a display area, and each of the first layout, the one or more transitional layouts, and the second layout can be displayed with respect to the display area. In some aspects, each of the first layout, the one or more transitional layouts, and the second layout substantially fill the display area. In some aspects, a zoom level of the second layout relative to the first layout corresponds to the length of the slide input.

Further, in some implementations, for at least one of the first layout, the one or more transitional layouts, and the second layout, at least one content item of the set of content items is a cropped version of an original content item.

A transition speed between the first layout and each of the one or more transitional layouts can correspond to a speed of the slide input, e.g., by being mapped in a linear fashion.

According to some implementations, the two spot inputs define a focal area therebetween and the technique further comprises identifying at least one focal content item of the set of content items corresponding to the focal area, wherein the predefined second layout includes the at least one focal content item and wherein the at least one focal content item is maintained at or near a center of the touch display in each of the one or more transitional layouts and the second layout.

According to some implementations, the second touch input comprises a first slide input from one of the spot inputs in a direction towards the other spot input, wherein the one or more transitional layouts comprise a first set of transitional layouts generated based on the direction and length of the first slide input, and the second touch input comprises a second slide input from the one or more spot inputs in a direction away from the other spot input, wherein the one or more transitional layouts comprise a second set of transitional layouts generated based on the direction and length of the second slide input.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example computing system according to some implementations of the present disclosure;

FIGS. 2A-2E illustrate example displays of layouts and transitional layouts of sets of content items in response to user touch inputs at a touch display of the example computing system of FIG. 1; and

FIG. 3 is a flow diagram of an example technique for displaying layouts and transitional layouts of sets of content items in response to user touch inputs according to some implementations of the present disclosure.

### DETAILED DESCRIPTION

As mentioned above, conventional techniques for viewing a collection of content items can be difficult and/or cumbersome for a user. For example, these conventional techniques can require buttons or other selectable icons for the user to control the viewing of the collection of content items. Accordingly, techniques are presented for displaying smooth and seamless transitions between layouts for sets of content items at a computing system in response to user touch inputs. In certain implementations, these techniques obviate the need for buttons or other selectable items in order to transition through viewing the collection of content items. It should be appreciated, however, that zoom buttons or selectable zoom icons and/or a zoom bar could be implemented as part of these techniques.

A computing system can initially display a first layout of a set of content items. A touch-sensitive display of the computing system can receive a first touch input comprising two spot inputs followed by a second touch input comprising a slide input from one of the spot inputs in a direction towards (“pinch-in”) or away from (“pinch-out”) the other spot input. Based on the direction and a length of this slide input, the computing system can display one or more transitional layouts of the set of content items. Through the use of one or more transitional layouts, these techniques are not limited to a certain number of fixed layouts for transitioning through viewing the collection of content items.

When the user has broken contact with the touch display, the computing system can display a second layout of the set of content items. That is, the display of the content items is transitioned from a first zoom level (displayed in the first layout) to a second zoom level (displayed in the second layout) through the one or more transitional layouts. The seamless morphing between zoom levels displays proximal content items (e.g., images taken proximally in time) in visual proximity in the display area (e.g., next to one another) to provide visual cues to facilitate a user's search for particular content items in the collection of content items.

In certain implementations, the transitional layout(s) and the second layout may be generated dynamically and automatically based on one or more factors including, but not limited to, the direction of the slide input, the length of the slide input, the focus area encompassed within the first touch input, the number of content items displayed in the first layout, the total number of content items available for display, and the like. The transitional layout(s) and the second layout may be dynamically generated and displayed on the touch display concurrently with receipt of the second touch input in real-time, i.e., without intentional delays. The transition speed at which the transitional layout(s) are updated may be based on the speed of the slide input such that the display morphs smoothly from the first layout to the second layout through the one or more transitional layouts.

Since the exemplary system provides the user smooth, real-time feedback on how the slide input affects the overall display, the user may better control the zoom level of the display by the speed of the slide input. The exemplary system may automatically adjust the display if the user pauses, reverses, or cancels the change of the display in the same slide input gesture. In certain implementations, when the user pauses the slide input at a particular transitional layout without removing or breaking contact with the touch display, the exemplary system may continue to display the particular transitional layout. In certain implementations, when the user reverses the direction of the slide input, the exemplary system may seamlessly transition to one of the prior transitional layout(s) displayed.

In cases in which the slide input is a “pinch-in,” the second layout may be a zoomed-out layout relative to the first layout, and may include the set of content items resized to be smaller than in the first layout and one or more additional content items. In cases in which the slide input is a “pinch-out,” the second layout may be a zoomed-in layout relative to the first layout, and may include a subset of the set of content items resized to be larger than in the first layout.

Although certain exemplary implementations are described with reference to “pinch” slide inputs, other slide inputs can include, but are not limited to, a rotation slide input or a twist slide input performed using one spot input (e.g., a user circling one or more content items with a single finger or stylus) or performed using two or more spot inputs (e.g., a user performing a twist movement around one or more content items using three, four, or five fingers). In an implementation in which a rotation or twist slide input is provided, a first direction (e.g., clockwise or counterclockwise) may indicate that the zoom level should be increased from the first layout to the second layout, while a second opposite direction (e.g., counterclockwise or clockwise) may indicate that the zoom level should be decreased from the first layout to the second layout.

The term “layout” as used herein can refer to a visual arrangement or configuration of one or more content items in a display area. A layout may be specified by, for example, the number of content items for display in the display area, the sizes of the content items, the arrangement of the content items relative to one another and relative to the display area, and the like. For example, a layout may be specified by (i) a size of at least one content item of the set of content items, (ii) an arrangement of at least one content item of the set of content items, and/or (iii) an additional content item in addition to the set of content items or a subset of the set of content items. In certain implementations, all of the content items displayed in a layout of a display area may be of substantially the same size, whereas, in certain other implementations, the sizes of the content items may vary.

The term “set of content items” as used herein can refer to one or more components displayed within a display area on a display device. The content items may be stored at a non-transitory storage or memory of the computing system or retrieved by a computing system via a network for display on the display device. In one non-limiting example, the content items displayed on a display device may be images or representations of images (e.g., thumbnail versions of the images, enlarged/expanded/uncropped versions of the images, cropped versions of the images, etc.). In another non-limiting example, the content items displayed on a display device may be videos or representations of video files (e.g., a frame of the video, an animation generated from the video, etc.). Other examples of content items include, but are not limited to, representations of files (e.g., filenames), events (e.g., calendar items), contacts (e.g., contact items from a list of contents), audio files or representations of audio files (e.g., an image associated with a song, an image associated with an album including the song, etc.). In certain other implementations, a display area may display content items of different types, e.g., images and videos.

While the term “content item” is discussed herein as representing a single content item (e.g., an image), each content item may represent a group of content items. For example, a content item may represent a folder or other labeled group of related content items. This can also be referred to as a “group content item.” The display of a group content item versus one or more of its associated content items can depend on the degree of zoom. For example, when the user zooms out the display, there may be too many content items to display, and thus the group content item could be displayed instead of at least some of its related content items. Similarly, for example, when the user zooms in the display and the group content item is already being displayed, the content items associated with the group content item could then be displayed instead. In certain implementations, this transition from displaying a group content item to displaying its related content items could be performed when the group content item would have been displayed having a size greater than a predetermined threshold. In other words, it could be preferable to display more content items as opposed to only one or two group content items.

The term “transitional layout” as used herein can refer to intermediate layout(s) that are displayed while the user is providing their slide input. In one implementation, a smooth animation or other suitable seamless display technique is utilized to display the transition from the first layout to the one or more transitional layouts to the second layout.

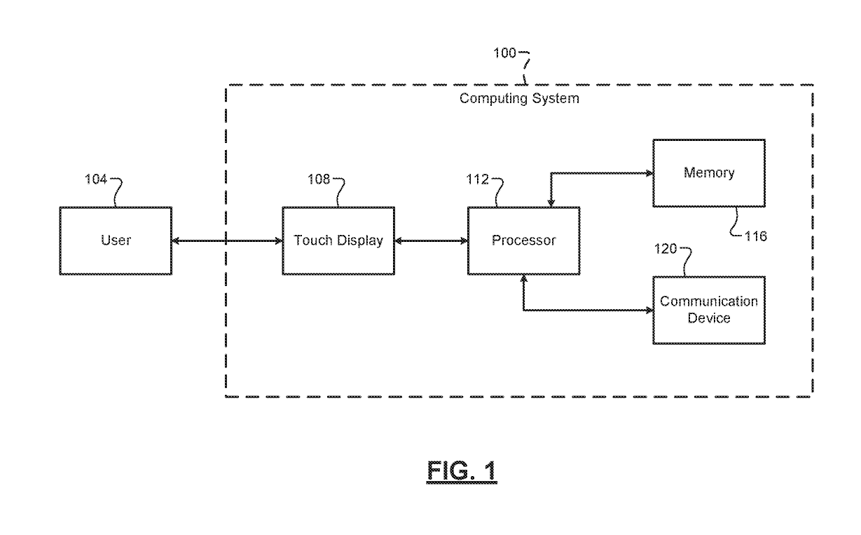

Referring now to FIG. 1, a functional block diagram of an example computing system 100 is illustrated. The computing system 100 can be any type of computing device or devices working in concert, such as a mobile phone, a tablet computer, a laptop computer, a desktop computer, a wearable computer, or a combination thereof. The computing system 100 is configured to receive input from and/or display information to a user 104. The computing system 100 can include a touch-sensitive display 108, a processor 112, a memory 116, and a communication device 120. The computing system 100 may also be referred to as a “touch computing system.” The touch display 108 is configured to receive touch input from the user 104 and/or display information. The processor 112 is configured to control operation of the computing system 100. The term “processor” as used herein can refer to both a single processor and two or more processors operating in a parallel or distributed architecture.

Example operations performed by the processor 112 include, but are not limited to, launching/executing an operating system of the computing system 100, interpreting touch input via the touch display 108, controlling information output at the touch display 108, controlling read/write operations at the memory 116, and controlling communication via the communication device 120. The memory 116 can be any suitable storage medium (flash, hard disk, etc.) configured to store information (e.g., a collection of photos) at the computing system 100. The communication device 120 can be any suitable communication device (e.g., a transceiver) configured to communicate via a network (e.g., to retrieve at least some photos of the collection of photos). The processor 100 is also configured to perform at least a portion of the techniques of the present disclosure, which are discussed in greater detail below.

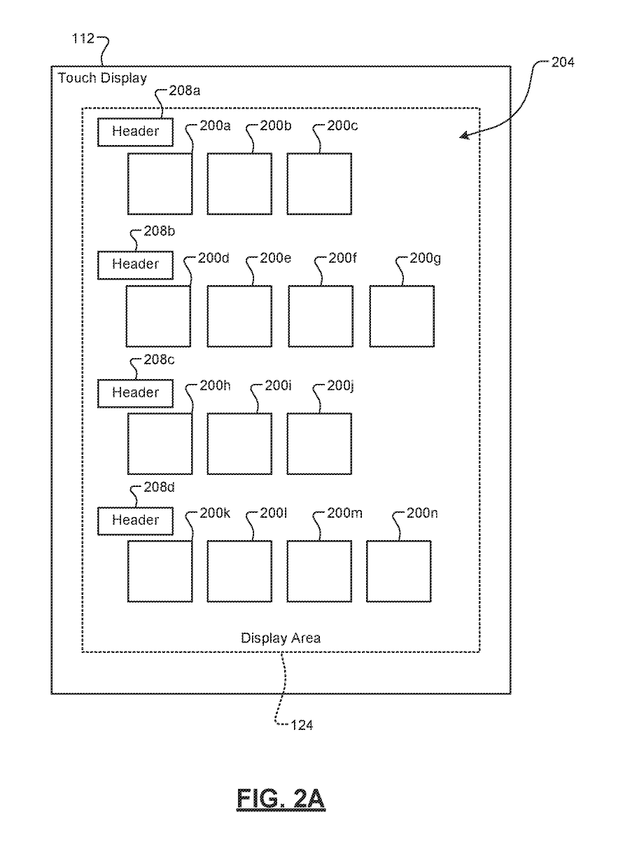

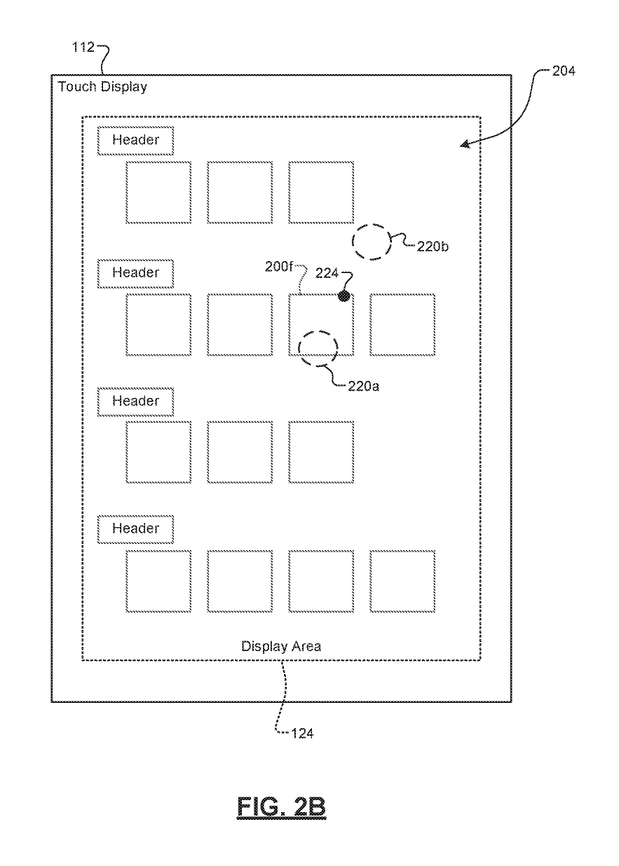

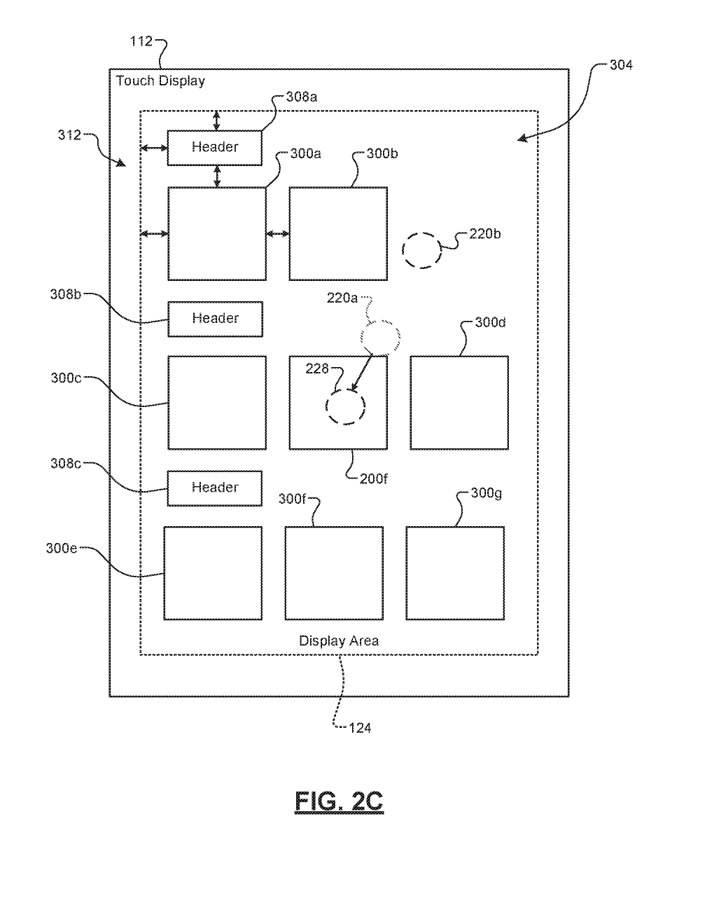

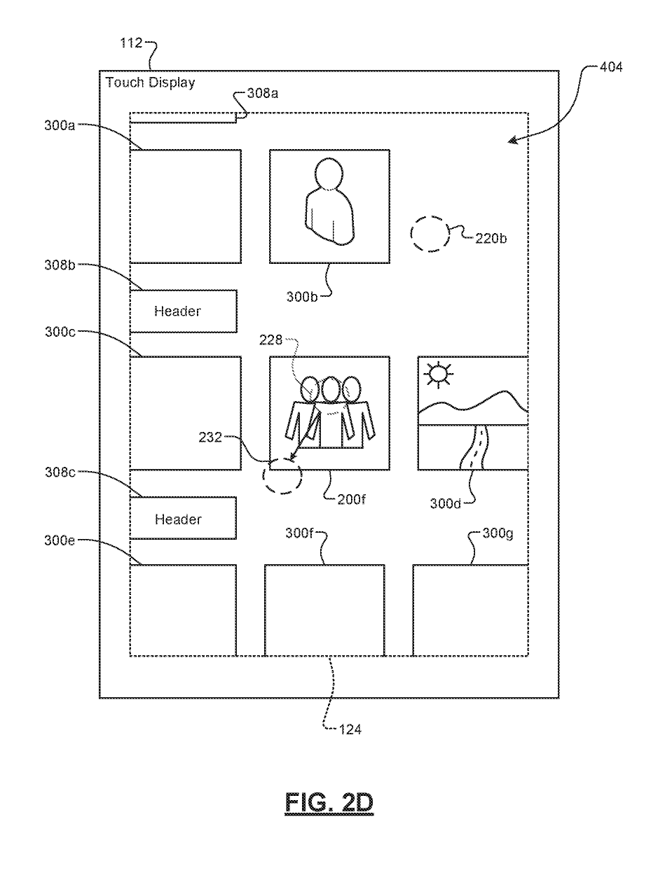

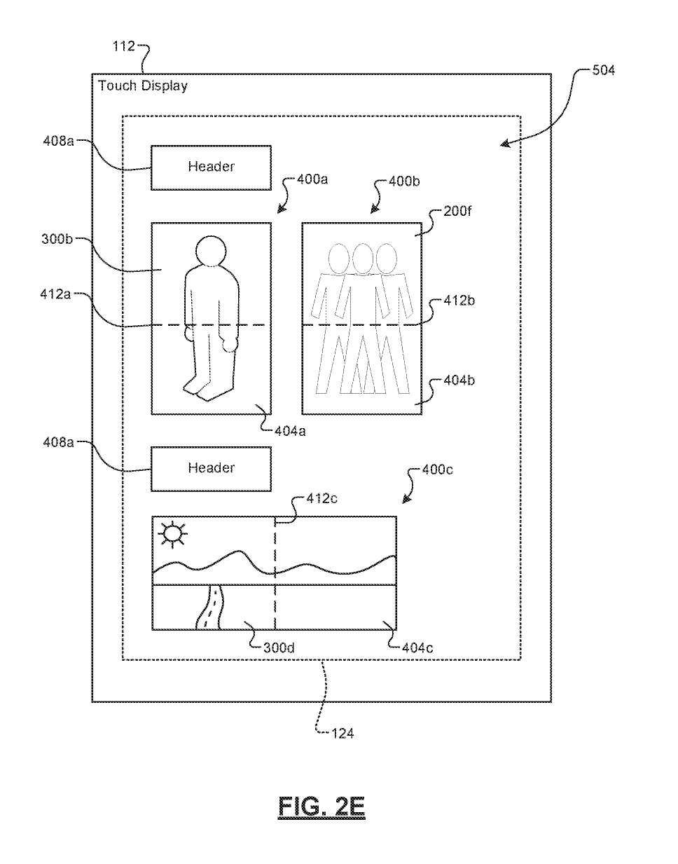

Referring now to FIGS. 2A-2E, diagrams of example displays of layouts of sets of content items in response to user touch inputs are illustrated. While these example displays of layouts and transitional layouts are shown and described with respect to the touch display 108 of the computing system 100, these techniques can be implemented by any suitable touch computing device.

FIG. 2A illustrates an example first layout 204 of a set of content items 200a . . . 200n (collectively “set of content items 200”). While fourteen content items are shown, the set of content items 200 can include any number of two or more content items. Optionally, the first layout 204 can divide the set of content items 200 into subsets of content items under respective headers 208a . . . 208d (collectively “headers 208”). The headers 208 can divide the set of content items into the subsets of content items based on a context of each content item. Example contexts include a range of times and/or dates at which the content item was obtained and an event or type of event at which the content item was obtained, but any suitable context can be used. In one implementation, the first layout 204 is a default layout of the computing system 100 or previously specified by the user 104.

FIG. 2B illustrates a first touch input by the user 104 with respect to the first layout 204. The first touch input can include two spot inputs 220a and 220b (collectively “spot inputs 220”). These spot inputs can be made using fingers or objects (e.g., a stylus) or some combination thereof. The two spot inputs 220 define a focal point or area 224 therebetween. For example, the focal area 224 may be determined as a midpoint along a line between the spot inputs 220. The focal area 224 may be indicative of a specific content item or content items with respect to which the user 104 desires to change or transition the first layout 204. As shown, the focal area 224 is on or near content item 200f of the set of content items 200. This content item 200f can also be referred to as the focal content item 200f.

FIG. 2C illustrates a second touch input by the user 104 with respect to the first layout 204. The second touch input comprises a first slide input from one of the spot inputs 220 in a direction towards (“pinch-in”) or away from (“pinch-out”) the other one of the spot inputs 220. As shown, the slide input ends at spot 228. For example, a slide input in a direction inwardly or towards the other one of the spot inputs 220 may increase a density of the displayed set of content items for a particular layout (e.g., more content items are displayed), whereas a slide input in a direction outwardly or away from the other one of the spot inputs 220 may decrease a density of the displayed set of content items for a particular layout (e.g., fewer content items are displayed). Thus, this second touch input causes the touch display 108 to display to a first transitional layout 304.

The first transitional layout 304 can be based on the direction and a length of the first slide input. The length of the first slide input can be indicative of a desired degree of change in the density of the displayed set of content items, whereas the direction of the first slide input can be indicative of the desired change in the density as discussed above.

As shown, the transitional layout 304 includes a set of content items comprising the focal content item 200f and other content items 300a . . . 300g (collectively “other content items 300”). These content items can be divided into subsets and associated with respective headers 308a . . . 308c (collectively “headers 308”). Some or all of these headers 308 may be the same as headers 208, but one or more of the headers 308 may be different (e.g., more specific than a previous header from headers 208 for the inward slide input shown). For example only, if the first layout 204 includes a header 208c that reads “January 2015,” the header 308b in the first transitional layout 304 could read “January 2015,” a more specific “January 1, 2015,” or any other context.

As previously discussed, group content items may also be displayed. For example only, for the header 208c that reads “January 2015” there may be ground content items labeled “Birthday” and “Skiing Trip.” Each of these group content items can include content items from January 2015 associated with Birthday and Skiing Trip events, respectively. As previously discussed, if the user had previously zoomed in to view only a set of content items associated with Birthday, the user could then zoom out and a group content item for Birthday could be displayed instead of the previous set of content items. The user could then, for example, zoom in with respect to the group content item for Skiing Trip and a set of content items for Skiing Trip could be displayed. Alternatively, the user could then zoom out further and a group content item for January 2015 could be displayed instead of the group content items Birthday and Skiing Trip. For example, the group content item January 2015 could be displayed along with similar group content items December 2014 and February 2015.

Similarly, some of these other content items 300 may be from the set of content items 200, but some of these other content items 300 may not be from the set of content items 200 but from a common collection of content items (e.g., stored at the memory 116). The selection of the content items to be displayed in the first transitional layout 304 can be based on the context of the content items. While the layouts are all described with respect to the set of content items, it should be appreciated that this can include modifying a view of the set of content items, adding content items to the set of content items 200, or removing content items from the set of content items 200. The first layout 204, the first transitional layout 304, and other layouts discussed below are each displayed with respect to a display area 124 of the touch display 108. For each layout, the displayed set of content items occupies substantially all of the display area 124. By effectively filling the entire display area 124 for each layout, these techniques differ from traditional zoom, e.g., in which a single content item is displayed at various different zoom levels such that the single content item could fill more or less than the entire display area.

The focal content item(s) 200f can be maintained at or near a center of the display area 124 in the transitional layout(s) and in the second layout and, in certain implementations, one or more additional content items may be reflowed around the focal content item 200f. As a result, the exemplary system advantageously maintains the visual context of the focal content item 200f with respect to its/their surrounding content items in the different zoom levels. In examples in which multiple focal content items are identified (e.g., where the spot inputs encompass two or more content items), the configuration of the focal content items relative to one another may be preserved or updated in the transitional layout(s) and the second layout to maximize the sizes of the focal content items while maximizing use of the display area on the display area. For example, if a single row of four content items form the focal content items, a zoomed-in transitional layout that only shows the focal content items may reconfigure the focal content items so that two focal content items are displayed side-by-side in a first row and the other two focal items are displayed side-by-side in a second row.

At least some of the content items can be resized (e.g., increased size for the inward slide input as shown) for display in the transitional layout(s) and the second layout. At least some of the content items may be rearranged, such as based on their respective headers 308. In certain examples, the configuration of the content items relative to one another may be preserved or updated in the transitional layout(s) and the second layout to maximize the sizes of the content items while maximizing use of the display area on the display area. For example, an absolute position of a content item relative to the coordinates of the display area and/or a relative position of a content item relative to the other content items may be changes in the transitional layout(s) and/or the second layout (i.e., moved to a different row, a different column, etc.). Further, as discussed above, the displayed set of content items can include additional or fewer content items than the original set of content items 200. The first transitional layout 304, however, can maintain constant margins between each of the content items, between the content items and the headers 308, and/or between the content items or headers and an edge of the display area 124. As a result, the transitional layout 304 appears clean and easily viewable by the user 104.

Referring now to FIG. 2D, the second touch input continues, including a further slide input from spot 228 to spot 232, which is in a direction away from the other one of the spot inputs 200 but having a shorter length than the earlier slide input. It should be noted that during these spot inputs and the two slide inputs, the user 104 does not break contact with the touch display 104 in a single touch operation. This subsequent slide input causes the touch display 108 to display a second transitional layout 404 that is different from the first transitional layout 304. More particularly, the second transitional layout 404 has an even lesser density than the first transitional layout 304. As shown, the second transitional layout 404 includes the same content items (focal content item 200f and other content items 300) and the same headers 308. Optionally, however, at least some of these objects are only partially displayed at an outer edge of the display area 124 to provide a seamless transition of the display. In other words, these content items/headers overlap the outer edge of the display area 124.

The first layout 204 transitions to one or transitional layouts 304, 404 at a transition speed. The transition speed between the first layout 204 and each of the one or more transitional layouts 304, 404 can correspond to a speed of the slide input. For example only, the transition speed and the speed of the slide input can be mapped in a substantially linear fashion. In this manner, a user 104 can more easily control the transition between the first layout 204, the one or more transitional layouts 304, 404, and a second layout, as further described below.

Referring now to FIG. 2E, the user 104 can break contact with the touch display 108 to end of the touch operation. In response to the user 104 breaking contact with the touch display 108, the touch display 108 can display a second layout 504 of the set of content items. In one implementation, the second layout 504 is one of a plurality of predefined layouts (predefined temporal-based layouts, user-defined layouts, etc.). The second layout 504, for example, may be selected from the plurality of predefined layouts based on the degree of density indicated by the second touch input. In certain implementations, however, the second layout is the last transitional layout. As shown, the second layout 504 includes the focal content item 200f and other content items 300b and 300d, along with headers 408a and 408b. The density of the second layout 504 is even lesser than the density of the second transitional layout 404.

In one implementation, the second layout 504 or another one of the layouts discussed herein can adjust at least some of the content items to their original aspect ratio (e.g., portrait/vertical or landscape/horizontal). In other words, the content items may typically be cropped, such as to obtain square thumbnail content items for easier arranging and clearer presentation. For example, this feature may be triggered when the layout is associated with a specific low degree of density. As shown, the focal content item 200f is part of an original portrait/vertical content item 400a having another portion 404a that was cropped off along line 412a. Similarly, other content item 300b is part of an original portrait/vertical content item 400b having another portion 404b that was cropped off along line 412b. Other content item 300d, on the other hand, is part of an original landscape/horizontal content item 400c having another portion 404c that was cropped off along line 412c.

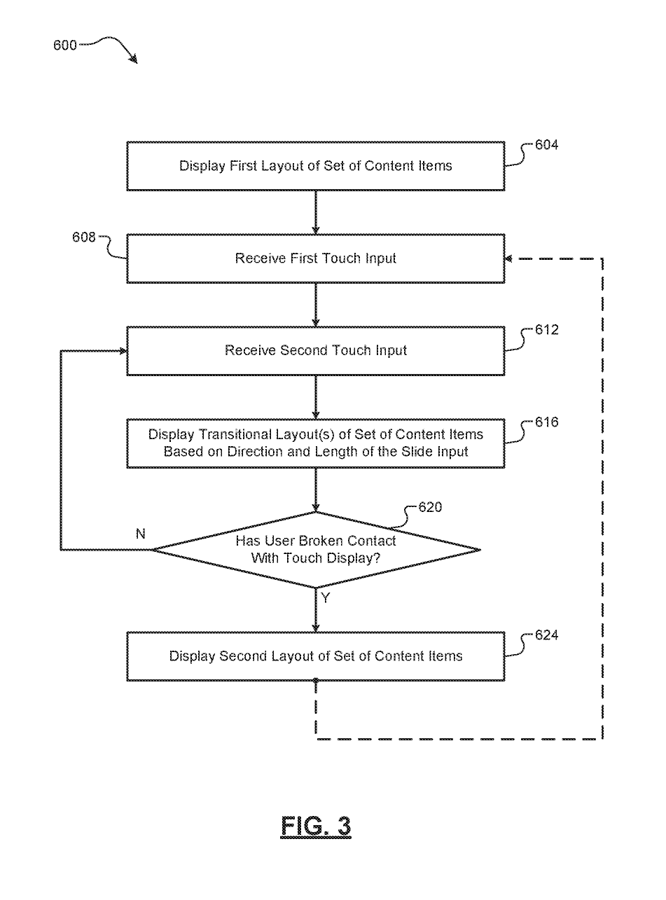

Referring now to FIG. 3, a flow diagram of an example technique 600 for displaying a transition between different layouts of sets of content items in response to user touch inputs is illustrated. At 604, the computing system 100 displays a first layout of a set of content items. At 608, the computing system 100 receives a first touch input comprising two spot inputs. At 612, the computing system 100 receives a second touch input comprising a slide input in a direction from one of the spot inputs in a direction towards or away from the other spot input. The slide input can also define a length. At 616, the computing system 100 can display one or more transitional layouts of the set of content items based on the direction and length of the slide input. At 620, the computing system 100 determines whether the user 104 has broken contact with the touch display 108. When the user has not broken contact with the touch display 108, the technique 600 can return to 612 (e.g., the slide input may continue). When the user 104 has broken contact with the touch display, the technique 600 can proceed to 624. At 624, the computing system 100 can display a second layout of the set of content items. The technique 600 can then end or return to 608 where the process could continue (e.g., the user 104 could further adjust the density).

In certain implementations, at 616 and 624, the transitional layout(s) and the second layout may be generated dynamically and automatically based on one or more factors including, but not limited to, the direction of the slide input, the length of the slide input, the focal content item(s) encompassed within the first touch input, the number of content items displayed in the first layout, the total number of content items available for display, and the like.

In one non-limiting example, in generating a particular transitional layout at a particular time during the slide input, the direction of the slide input may be used to determine whether to zoom-in or zoom-out. Similarly, the length of the slide input up to that particular time may be used to determine the magnitude of the zoom level change, i.e., the longer the length of the slide input, the higher the difference between the zoom level at the first layout and the zoom level at the current transitional layout. In some examples, the magnitude of the zoom level change may be varied in a substantially linear manner with the length of the slide input. A transitional size of the content items may then be determined based on the initial size of the content items and the determined magnitude of the zoom level change. The exemplary system may then generate a transitional layout by resizing the focal content item(s) based on the transitional size and placing the resized focal content item(s) at or near the center of the transitional layout. The exemplary system may then determine the number of other resized content items (i.e., content items resized based on the determined transitional size) that may be fully or partially accommodated in the display area around the focal content item(s). The exemplary system may populate the current transitional layout around the focal content item(s) with the determined number of resized content items that were in the visual proximity of the focal content item(s) in the original layout. In certain examples, one or more resized content items that can only be partially accommodated within the transitional layout may be partially displayed within the borders of the transitional layout. In these cases, upon the user breaking contact with the touch display, the partially displayed content items in the transitional layout may be excluded from the second layout.

In certain implementations, the final transitional layout displayed immediately prior to the user breaking contact with the touch display may be used as the second layout of the display. In certain other implementations, the second layout may be predefined. This predefined layout can be the same or different than a last transitional layout. Examples of the predefined layout include, but are not limited to, predefined layouts corresponding to specific temporal ranges (year, month, week, day, hour(s), etc.) and user-defined layout(s).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), erasable programmable read-only memories (EPROMs), electrically erasable programmable read-only memories (EEPROMs), magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
displaying, at a touch display of a computing system having one or more processors, a first layout of a set of content items;
receiving, at the touch display, a first touch input from a user, the first touch input comprising two spot inputs;
receiving, at the touch display, a second touch input comprising a slide input from one of the spot inputs in a direction towards or away from the other spot input, the slide input having a length;
displaying, at the touch display, one or more transitional layouts of at least one or more content items in the set of content items based on the direction and length of the slide input; and
when the user breaks contact with the touch display, displaying, at the touch display, a second layout of at least one or more of the set of content items.

2. The computer-implemented method of claim 1, wherein at least one of the one or more transitional layouts includes at least one content item of the set of content items being only partially displayed at an outer edge of the touch display.

3. The computer-implemented method of claim 1, wherein displaying the one or more transitional layouts includes at least one of:
(i) adjusting a size of at least one content item of the set of content items;
(ii) adjusting an arrangement of at least one content item of the set of content items;
(iii) displaying a subset of the set of content items; and
(iv) displaying at least one additional content item in addition to the set of content items.

4. The computer-implemented method of claim 3, wherein adjusting the size of at least one content item of the set of content items includes maintaining margins between each content item.

5. The computer-implemented method of claim 1, wherein the second layout is different than the first layout.

6. The computer-implemented method of claim 1, wherein the touch display includes a display area, and wherein each of the first layout, the one or more transitional layouts, and the second layout are displayed with respect to the display area.

7. The computer-implemented method of claim 6, wherein each of the first layout, the one or more transitional layouts, and the second layout substantially fill the display area.

8. The computer-implemented method of claim 1, wherein for at least one of the first layout, the one or more transitional layouts, and the second layout, at least one content item of the set of content items is a cropped version of an original content item.

9. The computer-implemented method of claim 1, wherein the two spot inputs define a focal area therebetween and wherein the method further comprises identifying at least one focal content item of the set of content items corresponding to the focal area,
wherein the second layout includes the at least one focal content item and wherein the at least one focal content item is maintained at or near a center of the touch display in each of the one or more transitional layouts and the second layout.

10. The computer-implemented method of claim 1, wherein a transition speed between the first layout and each of the one or more transitional layouts corresponds to a speed of the slide input.

11. The computer-implemented method of claim 1, wherein the content items are images.

12. The computer-implemented method of claim 1, wherein a zoom level of the second layout relative to the first layout corresponds to the length of the slide input.

13. The computer-implemented method of claim 1, wherein the second touch input comprises a first slide input from one of the spot inputs in a direction towards the other spot input, wherein the one or more transitional layouts comprise a first set of transitional layouts generated based on the direction and length of the first slide input, and
wherein the second touch input comprises a second slide input from the one or more spot inputs in a direction away from the other spot input, wherein the one or more transitional layouts comprise a second set of transitional layouts generated based on the direction and length of the second slide input.

14. The computer-implemented method of claim 1, wherein the one or more transitional layouts are generated and displayed in real-time with receipt of the second touch input.

15. The computer-implemented method of claim 1, wherein the first touch input includes three, four or five spot inputs.

16. A computing system, comprising:
a touch display configured to:
receive a first touch input from a user, the first touch input comprising two spot inputs, and
receive a second touch input comprising a slide input from one of the spot inputs in a direction towards or away from the other spot input, the slide input having a length; and
one or more processors configured to control the touch display to:
display a first layout of a set of content items,
display one or more transitional layouts of the set of content items based on the direction and length of the slide input, and
display a second layout of the set of content items when the user breaks contact with the touch display.

17. The computing system of claim 16, wherein at least one of the one or more transitional layouts includes at least one content item of the set of content items being only partially displayed at an outer edge of the touch display.

18. The computing system of claim 16, wherein displaying the one or more transitional layouts includes at least one of:
(i) adjusting a size of at least one content item of the set of content items;
(ii) adjusting an arrangement of at least one content item of the set of content items;
(iii) displaying a subset of the set of content items; and
(iv) displaying at least one additional content item in addition to the set of content items.

19. The computing system of claim 18, wherein adjusting the size of at least one content item of the set of content items includes maintaining margins between each content item.

20. The computing system of claim 19, wherein the second layout is different than the first layout.

21. The computing system of claim 16, wherein the touch display includes a display area, and wherein each of the first layout, the one or more transitional layouts, and the second layout are displayed with respect to the display area.

22. The computing system of claim 21, wherein each of the first layout, the one or more transitional layouts, and the second layout substantially fill the display area.

23. The computing system of claim 16, wherein for at least one of the first layout, the one or more transitional layouts, and the second layout, at least one content item of the set of content items is a cropped version of an original content item.

24. The computing system of claim 16, wherein the two spot inputs define a focal area therebetween and wherein the one or more processors are further configured to identify at least one focal content item of the set of content items corresponding to the focal area,
wherein the second layout includes the at least one focal content item and wherein the at least one focal content item is maintained at or near a center of the touch display in each of the one or more transitional layouts and the second layout.

25. The computing system of claim 16, wherein a transition speed between the first layout and each of the one or more transitional layouts corresponds to a speed of the slide input.
